(19) United States
(12) Patent Application Publication
(10) Pub. No.: US 2011/0149078 A1
(43) Pub. Date: Jun. 23, 2011

(54) WIRELESS ANTI-THEFT SECURITY COMMUNICATIONS DEVICE AND SERVICE

(75) Inventors: James Fan, San Ramon, CA (US); Ari Craine, Marietta, GA (US)

(73) Assignee: AT&T INTELLECTUAL PROPERTY I, LP, Reno, NV (US)

(21) Appl. No.: 12/641,461

(22) Filed: Dec. 18, 2009

(51) Int. Cl. H04N 7/18; H04N 5/232

(52) U.S. Cl. 348/152; 348/211.4; 348/E07.085; 348/E05.042

(57) ABSTRACT

A wireless anti-theft security communications service uses a wireless security device comprising a video camera, a force/wave sensor (e.g., accelerometer, motion detector, acoustic sensor, tilt sensor), a microphone, and a wireless communication component. Various levels of security are provided depending upon the configuration of the wireless security device. When a security breach is detected, the video camera and acoustic sensor(s) switch from stand-by mode to operating mode. A wireless session is initiated and video and audio information are sent to a designated destination via the wireless session.

### TECHNICAL FIELD

The technical field generally relates to security systems and more specifically relates to a security system comprising a wireless communications device.

### BACKGROUND

Typical home security systems trigger an outbound call to reach a security contractor or law enforcement officer when an intrusion is detected. A video camera can be installed which allows a user to monitor what is going on at home from a remote location via a connection (e.g., DSL or Cable Modem). A common automobile security system includes a camera installed on the automobile dash board to record events into a built-in digital card that later can be viewed via a PC device.

### SUMMARY

In an example configuration, a wireless anti-theft security communications device comprises a video camera, a force/wave sensor (e.g., accelerometer, motion detector, acoustic sensor, a pressure sensor, a tilt sensor, temperature), a microphone, and a wireless communications (e.g., 2.5G/3G/GPS) communication component. When an intrusion is detected by the force/wave sensor, the video camera and acoustic sensor(s) switch from stand-by mode to operating mode. A wireless session is initiated to reach the owner's wireless device and the video image along with the accompanied audio information is sent to the owner's wireless device. The wireless anti-theft security communications device is applicable to home and automobile use. A wireless anti-theft security communications service utilizing the wireless anti-theft security communications device can provide various levels of protection and deterrence.

### BRIEF DESCRIPTION OF THE DRAWINGS

FIG. 1 is a depiction of an example wireless anti-theft security communication service.

FIG. 2 is a block diagram of an example communications device configured to be controlled in accordance with motion of the communications device.

FIG. 3 depicts an overall block diagram of an exemplary packet-based mobile cellular network environment, such as a GPRS network, in which wireless anti-theft security communications services can be implemented.

FIG. 4 illustrates an example architecture of a typical GPRS network in which wireless anti-theft security communications services can be implemented.

FIG. 5 illustrates an exemplary block diagram view of a GSM/GPRS/IP multimedia network architecture within which wireless anti-theft security communications services can be implemented.

### DETAILED DESCRIPTION OF ILLUSTRATIVE EMBODIMENTS

A wireless anti-theft security communications service, provided by a telecommunications service provider or the like, utilizes a wireless security device comprising a video camera, a force/wave sensor (e.g., accelerometer, motion detector, acoustic sensor, temperature), a microphone, and a wireless (e.g., 2.5G/3G/GPS) communication component. The wireless anti-theft security communications service provider can offer various levels of security depending upon the configuration of the wireless security device and services provided.

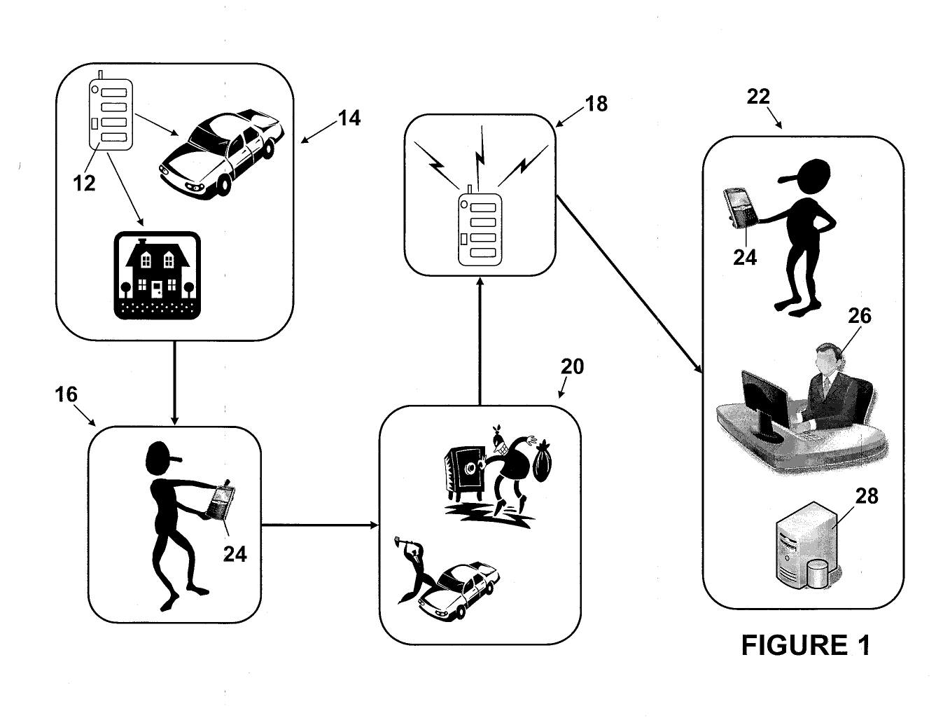

FIG. 1 is a depiction of an example wireless anti-theft security communication service. As depicted in FIG. 1, the wireless anti-theft security communications device is installed at an appropriate location (e.g., car, house, office, etc.). When an intruder breaks in, video and audio information is transmitted to a designated handset device (e.g., subscriber's cellular wireless communications device). Optionally, the video and audio information can be sent to security service agent or law enforcement entity. In addition, the video and audio information can be stored in a centralized secured data store to allow subsequent retrieval.

Referring to FIG. 1, at block 14, the wireless anti-theft security communications device 12 is installed in a vehicle, in a house, in an office, or the like. The wireless anti-theft security communications device is configured with an identification code, such as a cellular phone number or the like. In an example configuration, the wireless anti-theft security communications device comprises a sensor portion a video camera, transmission means (e.g., a wireless communication component), an acoustic sensor (e.g., microphone) and a force/wave sensor, such as a motion detector, accelerometer, acoustic sensor, temperature sensor, or the like. At block 16, the subscriber/owner of the wireless anti-theft security communications device 12 configures his/her wireless communications device 24 with a ringtone, alert tone, vibrations pattern, or the like, for calls received from the wireless anti-theft security communications device 12 (e.g., the identification code of the wireless anti-theft security communications device). In an example embodiment, as described in more detail below, the subscriber/owner, can remotely program (e.g., activate, deactivate, control, download, etc,) the wireless anti-theft security communications device 12 via his/her wireless communications device 24.

At block 20, a security breach occurs, and the force/wave sensor of the wireless anti-theft security communications device 12 detects the intrusion/break-in. The wireless anti-theft security communications device 12 initiates a wireless session to send the video and audio. At block 18, the wireless anti-theft security communications device 12 sends the video and audio to the subscriber/owner's wireless communications device 24, to a law enforcement or security entity 26, to a database 28, or a combination thereof as depicted in block 22. In an example embodiment, the database 28 represents a secure storage that can be accessed by an authorized entity, such as the subscriber/owner, the law enforcement/security entity, or the like. In an example embodiment, the wireless anti-theft security communications device identification code is stored in the database 28.

In an example embodiment, the subscriber/owner can remotely control the wireless anti-theft security communications device via his/her wireless communications device 24. For example, the subscriber/owner can control (steer, zoom in, zoom out, adjust lighting, etc.) the video camera of the wireless anti-theft security communications device, and/or establish two way communications between the wireless communications device 24 and the wireless anti-theft security communications device 12. In various example embodiments, control can be established via an authorization code (e.g., pass code) or the like, or can be allowed without a pass code. In various embodiments, the subscriber/owner also can, via his/her wireless communications device 24, remotely activate the wireless anti-theft security communications device, can deactivate the wireless anti-theft security communications device, can download information to the wireless anti-theft security communications device, or any combination thereof.

In an example application the wireless anti-theft security communications device is utilized as a monitoring device. For example, an owner of the wireless anti-theft security communications device can install the wireless anti-theft security communications device in an automobile that is being used to transport the owner's child to a destination (e.g., summer camp, school, etc.). While the child is driving the automobile, the owner can monitor the child's travel condition by using his/her wireless communication device to establish a two way video and audio communication session between the owner's wireless communications device and the wireless anti-theft security communications device. During the session, the owner can control the camera of the wireless anti-theft security communications device.

In an example embodiment, when the force/wave sensor detects activity that activates the anti-theft security communications device, the camera of the anti-theft security communications device automatically is steered in the direction of the activity. Thus, if activity occurs outside a vehicle for example (e.g., broken glass of a window resulting from a burglary attempt at a building in proximity to the parked vehicle), the camera is controlled to be steered in the direction of the activity. Thus captured video and audio of the burglary can be provided to the designated destination. The destination can be the subscriber/owner's wireless communications device, a designated storage, such as a database server or the like, a security/law enforcement entity, or any combination thereof. In an example embodiment, when the subscriber/owner realizes, via viewing the video and/or listening to the audio, that the information being captured pertains to activity not involving the subscriber/owner's vehicle, the subscriber/owner can remotely control, via his/her wireless communications device, the information to be sent to designated storage and/or to a security/law enforcement entity.

The anti-theft security communications device can be remotely activated, remotely deactivated, and/or remotely controlled by the subscriber/owner as described above. In another example embodiment, the anti-theft security communications device can be activated/deactivated/controlled by an authorized party (e.g., security entity, law enforcement entity, etc.) other than the subscriber/owner. For example, the subscriber/owner can agree to allow a local law enforcement entity (e.g., local police department) to remotely activate, deactivate, and/or control the anti-theft security communications device. Thus, if the local law enforcement entity is aware of suspicious activity, or the like, in an area, and the local law enforcement entity knows the location of an anti-theft security communications device (via the anti-theft security communications device's ability to provide location information via GPS, A-GPS, etc.), the local law enforcement entity can activate the anti-theft security communications device (or anti-theft security communications devices in the area) can control the anti-theft security communications device to capture video and audio of the area in an attempt to capture and optionally record the suspicious activity. The subscriber/owner could be motivated (provide an incentive) to allow authorized parties to remotely activate, deactivate, and/or control his/her anti-theft security communications device via a reduction is subscription fees, discounts, coupons, or the like.

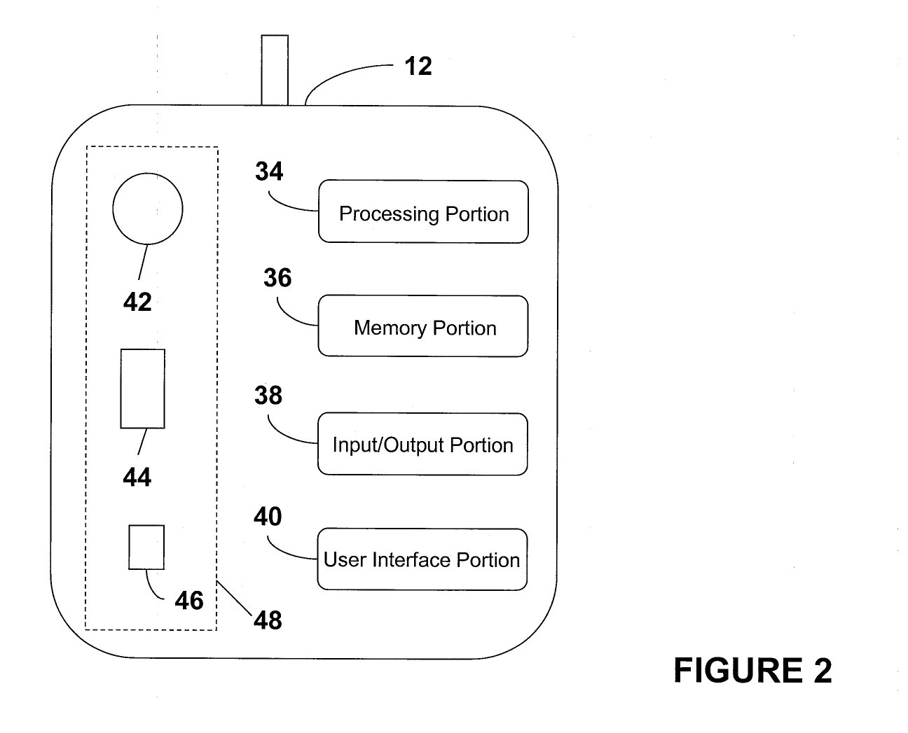

FIG. 2 is a block diagram of an example wireless anti-theft security communications device 12. In an example configuration, the wireless anti-theft security communications device 12 is a mobile wireless device. The wireless anti-theft security communications device 12 can include any appropriate device, mechanism, software, and/or hardware for providing security as described herein. In an example configuration, the wireless anti-theft security communications device 12 comprises a processing portion 34, a memory portion 36, an input/output portion 38, a user interface (UI) portion 40, and a sensor portion 48 comprising at least one of a video camera portion 42, a force/wave sensor 44, a microphone 46, or a combination thereof. The force/wave sensor comprises at least one of a motion detector, an accelerometer, an acoustic sensor, a tilt sensor, a pressure sensor, a temperature sensor, or the like. The motion detector is configured to detect motion occurring outside of the wireless anti-theft security communications device, for example via disturbance of a standing wave, via electromagnetic and/or acoustic energy. The accelerator is capable of sensing acceleration, motion, and/or movement of the wireless anti-theft security communications device. The acoustic sensor is capable of sensing acoustic energy, such as a loud noise, for example. The tilt sensor is capable of detecting a tilt of the wireless anti-theft security communications device. The pressure sensor is capable of sensing pressure against the wireless anti-theft security communications device, such as from a shock wave caused by broken glass or the like. The temperature sensor is capable of sensing an measuring temperature, such as inside of the vehicle, room, building, or the like. The processing portion 34, memory portion 36, input/output portion 38, user interface (UI) portion 40, video camera portion 42, force/wave sensor 44, and microphone 46 are coupled together to allow communications therebetween (coupling not shown in FIG. 2).

In an example embodiment, the processing portion 34, utilizing information from the sensor portion 48, is capable of (via appropriate signal processing algorithms and techniques) to distinguish between a loud noise such a siren for example, and the sound of breaking glass. Thus, the wireless anti-theft security communications device 12 is configured to distinguish between a security breach and a false alarm (an event known not to be a security breach. For example, the wireless anti-theft security communications device can utilize spectral filtering, can compare known signatures of a security breach with captured sensor information, or the like, to distinguish between a security breach and a false alarm. In an example embodiment, a library of known types of security breaches (e.g., broken glass, sensor information indicative of a radio or the like being removed, sensor information indicative of a car door be forcibly opened, etc,) can be maintained and updated as needed. The known signatures can be compared to received sensor information to determine if a security breach is occurring.

In an example embodiment, the wireless anti-theft security communications device can comprise a list of security breach signatures preloaded by the service provider or the like. These signatures can be compared with information collected by one or more sensors. The correlated data can be ranked e.g., from 1 to 5 level, for example. Wherein, level 1 is indicative of general monitoring (implies any minor activity sensed, to which the wireless anti-theft security communications device will react). And, level 5 can be indicative of a combination of predetermined levels, such as for example, (a) greater than or equal to xx (e.g., 60) decibel (dB) noise sensed,+greater than or equal to xxx (e.g., 10) lbs of pressure sensed+motion within 10 feet or less detected, (b) door unlocked in an unauthorized manner, (c) engine started not using the car key, (d) temperature exceed 120 degrees F., etc. Levels 2-4 can be indicative of sensor indications between level 1 and level 5. The subscriber can direct the wireless anti-theft security communications device what to do based on the level detected. For example, one signature could be noise level 300 db and pressure 10 lbs to imply a glass broken event (a level 5 event).

The wireless anti-theft security communications device also can be configured to possess adaptive learning capability. For example, a noise level of 100 db is detected but detected pressure is only 3 lbs which triggered a level 2 alert. However, the subscriber can direct the wireless anti-theft security communications device to memorize this instance and add it to level 5 alert list going forward. On the other hand, if an alert is received that the car temperature is more than 120 degree and the subscriber decided to move this situation to be false alarm category, next time, the wireless anti-theft security communications device will only record the alert but not send the alert.

In various embodiments, the input/output portion 38 comprises a receiver of the wireless anti-theft security communications device 12, a transmitter of the wireless anti-theft security communications device 12, or a combination thereof. The input/output portion 38 is capable of receiving and/or providing information pertaining to providing security via the wireless anti-theft security communications device 12 as described herein. For example, the input/output portion 38 can include a wireless communications (e.g., 2.5G/3G/GPS) SIM card. The input/output portion 38 is capable of receiving and/or sending a video information, audio information, control information, or any combination thereof, as described herein. In an example embodiment, the input/output portion 38 is capable of receiving and/or sending information to determine a location of the wireless anti-theft security communications device 12. In an example configuration, the input\output portion 38 comprises a GPS receiver. In various configurations, the input/output portion 38 can receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof.

The processing portion 34 is capable of performing functions pertaining to providing security via the wireless anti-theft security communications device 12 as described herein. For example, the processing portion 34 is capable of initiating a communications session upon receiving an indication of a security breach from the force/wave sensor, initiating and control transmission of video and audio information, control the angle of video camera portion 42, control the zoom factor of the video camera portion 42, control the focus of video camera portion 42, control the video camera portion 42 to zoom in, control the video camera portion 42 to zoom out, control the light sensitivity of video camera portion 42, distinguishing between a security breach and a false alarm (e.g., spectral filtering, comparing known signatures of a security breach with captured sensor information, etc.), as described above, or any combination thereof.

In a basic configuration, the wireless anti-theft security communications device 12 can include at least one memory portion 36. The memory portion 36 can store any information utilized in conjunction with providing security via the wireless anti-theft security communications device 12 as described herein. For example, the memory portion 36 is capable of storing information pertaining to location of a wireless anti-theft security communications device 12, subscriber profile information, subscriber identification information, designated phone numbers to send video and audio information, an identification code (e.g., phone number) of the wireless anti-theft security communications device, video information, audio information, control information, or any combination thereof, as described herein. Depending upon the exact configuration and type of processor, the memory portion 36 can be volatile (such as some types of RAM), non-volatile (such as ROM, flash memory, etc.), information indicative of signatures (e.g., raw individual sensor information, combination of sensor information, processed sensor information, etc.) of known types of security breaches, information indicative of signatures of known types of false alarms (known not to be a security breach), or a combination thereof. The wireless anti-theft security communications device 12 can include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the mobile wireless anti-theft security communications device 12.

The wireless anti-theft security communications device 12 also can contain a UI portion 40 allowing a user to communicate with the wireless anti-theft security communications device 12. The UI portion 40 is capable of rendering any information utilized in conjunction with providing security via the wireless anti-theft security communications device 12 as described herein. For example, the UI portion 40 can provide means for entering text, entering a phone number, rendering text, rendering images, rendering multimedia, rendering sound, rendering video, or the like, as described herein. The UI portion 40 can provide the ability to control the wireless anti-theft security communications device 12, via, for example, buttons, soft keys, voice actuated controls, a touch screen, movement of the mobile wireless anti-theft security communications device 12, visual cues (e.g., moving a hand in front of a camera on the mobile wireless anti-theft security communications device 12), or the like. The UI portion 40 can provide visual information (e.g., via a display), audio information (e.g., via speaker), mechanically (e.g., via a vibrating mechanism), or a combination thereof. In various configurations, the UI portion 40 can comprise a display, a touch screen, a keyboard, a speaker, or any combination thereof. The UI portion 40 can comprise means for inputting biometric information, such as, for example, fingerprint information, retinal information, voice information, and/or facial characteristic information. The UI portion 40 can be utilized to enter an indication of the designated destination (e.g., the phone number, IP address, or the like).

In an example embodiment, the sensor portion of the wireless anti-theft security communications device 12 comprises the video camera portion 42, the force/wave sensor 44, and the microphone 46. The video camera portion 42 comprises a camera and associated equipment capable of capturing video and to provide the captured video to other portions of the wireless anti-theft security communications device 12. Still images also can be capture via the video camera portion 42. In an example embodiment, the force/wave sensor 44 comprises an accelerometer, a tilt sensor, an acoustic sensor capable of sensing acoustic energy, an optical sensor (e.g., infrared), or any combination thereof.

The wireless anti-theft security communications device can be configured, and associated security services can be provided in various embodiments. In one example embodiment, the wireless anti-theft security communications device comprises the video camera, the force/wave sensor, the microphone, the wireless communications SIM Card, a preconfigured outbound communication number, a battery slot (e.g., for a 9-volt battery, AAA battery, etc.), an operating/standby/off switch. In the is embodiment, the wireless anti-theft security communications service can offer the following features. The wireless anti-theft security communications device uses an activation process similar to a wireless handset. When the wireless anti-theft security communications device is switched to a stand-by mode, a delay is initiated (e.g., 20 second delay) before the force/wave sensor starts to operate. When the force/wave sensor detects an intrusion, the wireless anti-theft security communications device will auto dial the preconfigured outbound communication number and start to transmit the captured video and audio information to the designated remote device.

In another example embodiment, the wireless anti-theft security communications device comprises a key pad, a display (e.g., an LED display, or the like), a rechargeable battery pack, and a power indicator (e.g., light). The key pad can be an integral or attached part of the wireless anti-theft security communications device or can be a remote key pad. Along with the services provided above, the wireless anti-theft security communications service, in this embodiment, can offer the following additional services. The (wireless) key pad and the display allowing the owner to key in outbound communication number. The (wireless) key pad and the display allowing the owner to key in a secured pass-code. This pass-code allows the owner to disable the external operating/stand-by/off switch and to soft control the switch mode. When the wireless anti-theft security communications device is switched/set to the stand-by mode, a delay can be initiated (e.g., 20 second delay) before the force/wave sensor starts to operate. When the wireless anti-theft security communications device is equipped with a wireless key pad, the owner can set the mode remotely. When the force/wave sensor detects an intrusion, the wireless anti-theft security communications device will automatically dial the preconfigured outbound number and start to transmit the captured video and audio information to the designated remote device. The rechargeable battery pack can be charged in a car or in a home location. When power is low, the power indicator can provide an indication thereof (e.g., blinking).

In yet another example embodiment, the wireless anti-theft security communications device comprises a two way speaker phone and GPS integration with a video screen. The video screen can optionally comprise a touch screen. Along with the services provided above, the wireless anti-theft security communications service, in this embodiment, can offer the following additional services. The (wireless) key pad and the GPS video screen allowing the owner to key in the outbound communication number. The (wireless) key pad and the GPS video display allowing the owner to key in a secured pass-code. This pass-code allows the owner to disable the external operating/stand-by/off switch and to soft control the switch mode. The wireless anti-theft security communications device can receive an SMS type message from a remote device (e.g., a wireless communications device) which causes the wireless anti-theft security communications device to switch from a stand-by mode to an operating mode. The remote device can send SMS-type messages to the wireless anti-theft security communications device to control the camera (angle, focus, light sensitivity, zoom, etc.) and the volume of the speaker phone. The wireless anti-theft security communications device in conjunction with the GPS video capability allows a two way video and audio communication. Utilizing the GPS functionality, the owner can be provided, via his/her wireless communications device, the location of the wireless anti-theft security communications service. Thus, if a car has been stolen, the owner can receive an indication of the location of the car overlaid on a geographical map. When receiving a communication from the wireless anti-theft security communications service, if the owner is on another call, the call can be preempted, (but not disconnect). Further, a centralized secured database can be utilized to store the video/audio information received from the wireless anti-theft security communications device and can be associated with the wireless anti-theft security communications device identification code and a timestamp. The centralized store video/audio information can be retrieved by subscriber/owner, security service agent, or law enforcement staff on demand.

In an example embodiment, the wireless anti-theft security communications device is integrated with existing security functions, in a vehicle for example, to perform engine ignition lock, door lock, loud speaker, steering wheel lock, etc. The subscriber's/owner's remote device can issue command to trigger these integrated functions to discourage the theft to take further actions.

The wireless anti-theft security communications device 12 can be part of and/or in communication with various wireless communications networks. Some of which are described below. In various embodiments, the anti-theft security communications device can be pre-installed in a vehicle during manufacture and assembly. For example, the anti-theft security communications device can be integrated with the vehicle radio to hide its physical existence, and/or the anti-theft security communications device can be a totally detached unit integrated with functionality being integrated with other alarm devices to allow an alarm to be triggered via a push button, or the like.

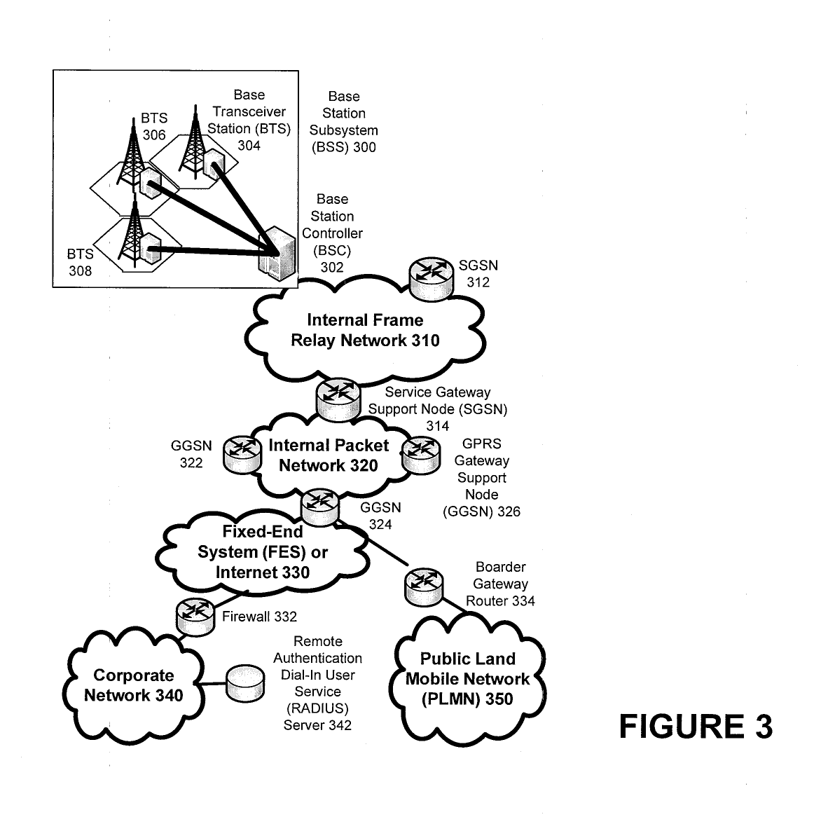

FIG. 3 depicts an overall block diagram of an exemplary packet-based mobile cellular network environment, such as a GPRS network, in which wireless anti-theft security communications services can be implemented. In the exemplary packet-based mobile cellular network environment shown in FIG. 3, there are a plurality of Base Station Subsystems (“BSS”) 300 (only one is shown), each of which comprises a Base Station Controller (“BSC”) 302 serving a plurality of Base Transceiver Stations (“BTS”) such as BTSs 304, 306, and 308. BTSs 304, 306, 308, etc. are the access points where users of packet-based mobile devices become connected to the wireless network. In exemplary fashion, the packet traffic originating from user devices is transported via an over-the-air interface to a BTS 308, and from the BTS 308 to the BSC 302. Base station subsystems, such as BSS 300, are a part of internal frame relay network 310 that can include Service GPRS Support Nodes (“SGSN”) such as SGSN 312 and 314. Each SGSN is connected to an internal packet network 320 through which a SGSN 312, 314, etc. can route data packets to and from a plurality of gateway GPRS support nodes (GGSN) 322, 324, 326, etc. As illustrated, SGSN 314 and GGSNs 322, 324, and 326 are part of internal packet network 320. Gateway GPRS serving nodes 322, 324 and 326 mainly provide an interface to external Internet Protocol (“IP”) networks such as Public Land Mobile Network (“PLMN”) 350, corporate intranets 340, or Fixed-End System (“FES”) or the public Internet 330. As illustrated, subscriber corporate network 340 may be connected to GGSN 324 via firewall 332; and PLMN 350 is connected to GGSN 324 via boarder gateway router 334. The Remote Authentication Dial-In User Service (“RADIUS”) server 342 may be used for caller authentication when a user of a mobile cellular device calls corporate network 340.

Generally, there can be a several cell sizes in a GSM network, referred to as macro, micro, pico, femto and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. Femto cells have the same size as pico cells, but a smaller transport capacity. Femto cells are used indoors, in residential, or small business environments. On the other hand, umbrella cells are used to cover shadowed regions of smaller cells and fill in gaps in coverage between those cells.

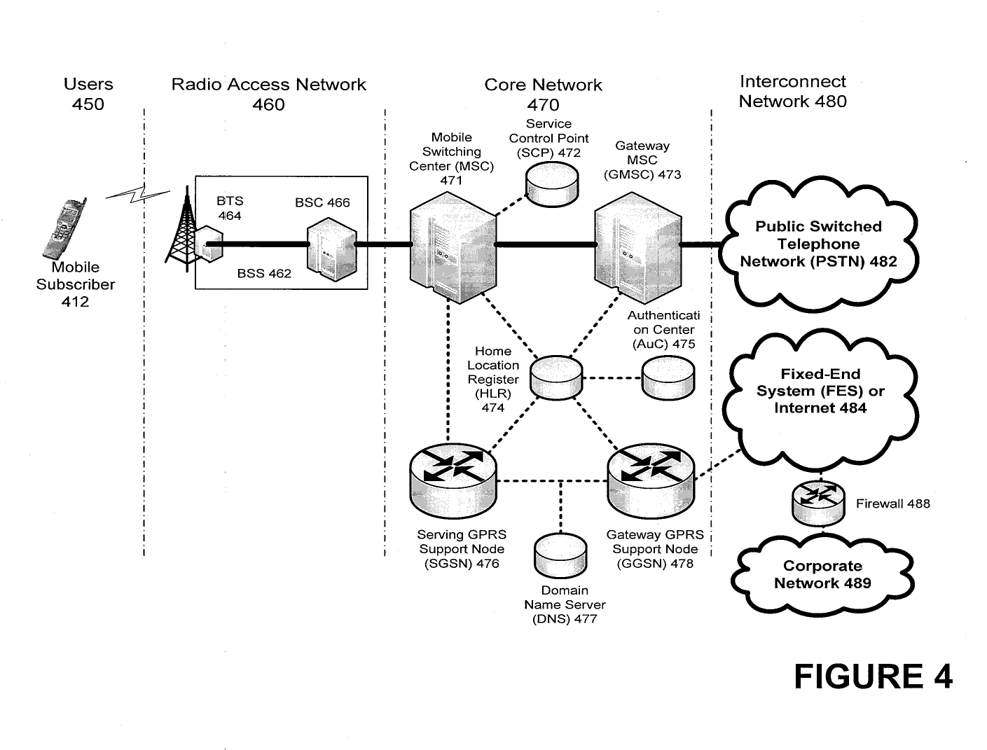

FIG. 4 illustrates an architecture of a typical GPRS network in which wireless anti-theft security communications services can be implemented. The architecture depicted in FIG. 4 is segmented into four groups: users 450, radio access network 460, core network 470, and interconnect network 480. Users 450 comprise a plurality of end users. Note, device 412 is referred to as a mobile subscriber in the description of network shown in FIG. 4. In an example embodiment, the device depicted as mobile subscriber 412 comprises a communications device (e.g., wireless anti-theft security communications device 12). Radio access network 460 comprises a plurality of base station subsystems such as BSSs 462, which include BTSs 464 and BSCs 466. Core network 470 comprises a host of various network elements. As illustrated in FIG. 4, core network 470 may comprise Mobile Switching Center (“MSC”) 471, Service Control Point (“SCP”) 472, gateway MSC 473, SGSN 476, Home Location Register (“HLR”) 474, Authentication Center (“AuC”) 475, Domain Name Server (“DNS”) 477, and GGSN 478. Interconnect network 480 also comprises a host of various networks and other network elements. As illustrated in FIG. 4, interconnect network 480 comprises Public Switched Telephone Network (“PSTN”) 482, Fixed-End System (“FES”) or Internet 484, firewall 488, and Corporate Network 489.

A mobile switching center can be connected to a large number of base station controllers. At MSC 471, for instance, depending on the type of traffic, the traffic may be separated in that voice may be sent to Public Switched Telephone Network (“PSTN”) 482 through Gateway MSC (“GMSC”) 473, and/or data may be sent to SGSN 476, which then sends the data traffic to GGSN 478 for further forwarding.

When MSC 471 receives call traffic, for example, from BSC 466, it sends a query to a database hosted by SCP 472. The SCP 472 processes the request and issues a response to MSC 471 so that it may continue call processing as appropriate.

The HLR 474 is a centralized database for users to register to the GPRS network. HLR 474 stores static information about the subscribers such as the International Mobile Subscriber Identity (“IMSI”), subscribed services, and a key for authenticating the subscriber. HLR 474 also stores dynamic subscriber information such as the current location of the mobile subscriber. Associated with HLR 474 is AuC 475. AuC 475 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 4, when mobile subscriber 412 initiates the attach process by turning on the network capabilities of the mobile device, an attach request is sent by mobile subscriber 412 to SGSN 476. The SGSN 476 queries another SGSN, to which mobile subscriber 412 was attached before, for the identity of mobile subscriber 412. Upon receiving the identity of mobile subscriber 412 from the other SGSN, SGSN 476 requests more information from mobile subscriber 412. This information is used to authenticate mobile subscriber 412 to SGSN 476 by HLR 474. Once verified, SGSN 476 sends a location update to HLR 474 indicating the change of location to a new SGSN, in this case SGSN 476. HLR 474 notifies the old SGSN, to which mobile subscriber 412 was attached before, to cancel the location process for mobile subscriber 412. HLR 474 then notifies SGSN 476 that the location update has been performed. At this time, SGSN 476 sends an Attach Accept message to mobile subscriber 412, which in turn sends an Attach Complete message to SGSN 476.

After attaching itself with the network, mobile subscriber 412 then goes through the authentication process. In the authentication process, SGSN 476 sends the authentication information to HLR 474, which sends information back to SGSN 476 based on the user profile that was part of the user's initial setup. The SGSN 476 then sends a request for authentication and ciphering to mobile subscriber 412. The mobile subscriber 412 uses an algorithm to send the user identification (ID) and password to SGSN 476. The SGSN 476 uses the same algorithm and compares the result. If a match occurs, SGSN 476 authenticates mobile subscriber 412.

Next, the mobile subscriber 412 establishes a user session with the destination network, corporate network 489, by going through a Packet Data Protocol (“PDP”) activation process. Briefly, in the process, mobile subscriber 412 requests access to the Access Point Name (“APN”), for example, UPS.com, and SGSN 476 receives the activation request from mobile subscriber 412. SGSN 476 then initiates a Domain Name Service (“DNS”) query to learn which GGSN node has access to the UPS.com APN. The DNS query is sent to the DNS server within the core network 470, such as DNS 477, which is provisioned to map to one or more GGSN nodes in the core network 470. Based on the APN, the mapped GGSN 478 can access the requested corporate network 489. The SGSN 476 then sends to GGSN 478 a Create Packet Data Protocol (“PDP”) Context Request message that contains necessary information. The GGSN 478 sends a Create PDP Context Response message to SGSN 476, which then sends an Activate PDP Context Accept message to mobile subscriber 412.

Once activated, data packets of the call made by mobile subscriber 412 can then go through radio access network 460, core network 470, and interconnect network 480, in a particular fixed-end system or Internet 484 and firewall 488, to reach corporate network 489.

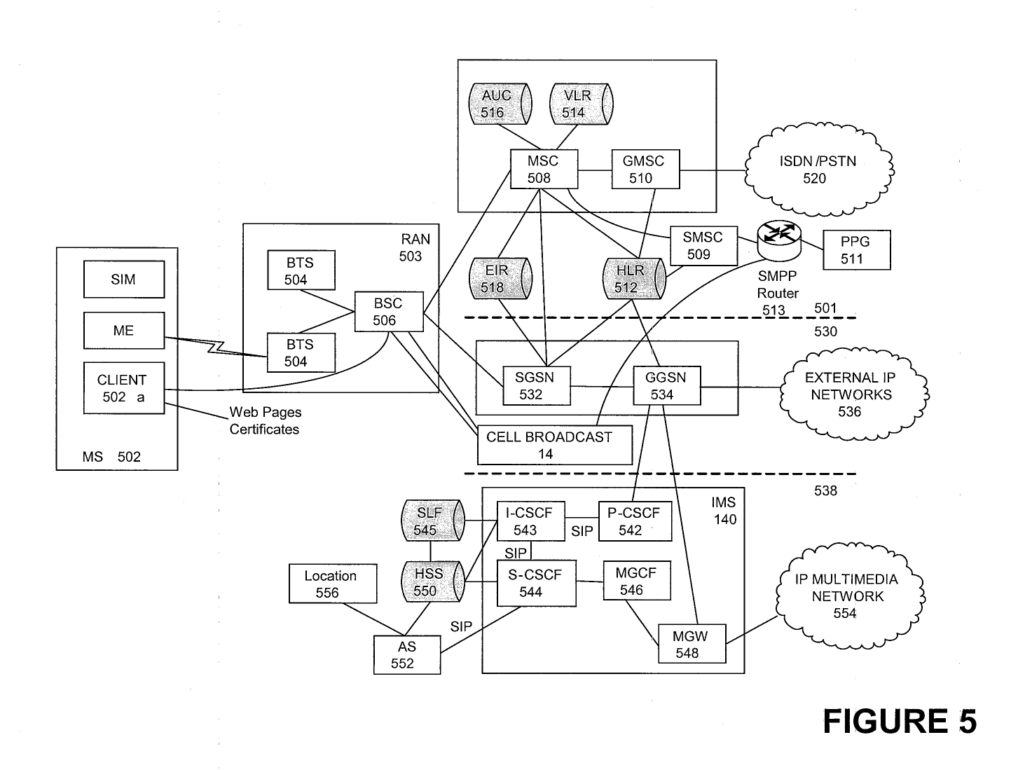

FIG. 5 illustrates an exemplary block diagram view of a GSM/GPRS/IP multimedia network architecture within which wireless anti-theft security communications services can be implemented. As illustrated, the architecture of FIG. 5 includes a GSM core network 501, a GPRS network 530 and an IP multimedia network 538. The GSM core network 501 includes a Mobile Station (MS) 502, at least one Base Transceiver Station (BTS) 504 and a Base Station Controller (BSC) 506. The MS 502 is physical equipment or Mobile Equipment (ME), such as a mobile phone or a laptop computer that is used by mobile subscribers, with a Subscriber identity Module (SIM) or a Universal Integrated Circuit Card (UICC). The SIM or UICC includes an International Mobile Subscriber Identity (IMSI), which is a unique identifier of a subscriber. The BTS 504 is physical equipment, such as a radio tower, that enables a radio interface to communicate with the MS. Each BTS may serve more than one MS. The BSC 506 manages radio resources, including the BTS. The BSC may be connected to several BTSs. The BSC and BTS components, in combination, are generally referred to as a base station (BSS) or radio access network (RAN) 503.

The GSM core network 501 also includes a Mobile Switching Center (MSC) 508, a Gateway Mobile Switching Center (GMSC) 510, a Home Location Register (HLR) 512, Visitor Location Register (VLR) 514, an Authentication Center (AuC) 518, and an Equipment Identity Register (EIR) 516. The MSC 508 performs a switching function for the network. The MSC also performs other functions, such as registration, authentication, location updating, handovers, and call routing. The GMSC 510 provides a gateway between the GSM network and other networks, such as an Integrated Services Digital Network (ISDN) or Public Switched Telephone Networks (PSTNs) 520. Thus, the GMSC 510 provides interworking functionality with external networks.

The HLR 512 is a database that contains administrative information regarding each subscriber registered in a corresponding GSM network. The HLR 512 also contains the current location of each MS. The VLR 514 is a database that contains selected administrative information from the HLR 512. The VLR contains information necessary for call control and provision of subscribed services for each MS currently located in a geographical area controlled by the VLR. The HLR 512 and the VLR 514, together with the MSC 508, provide the call routing and roaming capabilities of GSM. The AuC 516 provides the parameters needed for authentication and encryption functions. Such parameters allow verification of a subscriber's identity. The EIR 518 stores security-sensitive information about the mobile equipment.

A Short Message Service Center (SMSC) 509 allows one-to-one Short Message Service (SMS) messages to be sent to/from the MS 502. A Push Proxy Gateway (PPG) 511 is used to “push” (i.e., send without a synchronous request) content to the MS 502. The PPG 511 acts as a proxy between wired and wireless networks to facilitate pushing of data to the MS 502. A Short Message Peer to Peer (SMPP) protocol router 513 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 502 sends a location update including its current location information to the MSC/VLR, via the BTS 504 and the BSC 506. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 530 is logically implemented on the GSM core network architecture by introducing two packet-switching network nodes, a serving GPRS support node (SGSN) 532, a cell broadcast and a Gateway GPRS support node (GGSN) 534. The SGSN 532 is at the same hierarchical level as the MSC 508 in the GSM network. The SGSN controls the connection between the GPRS network and the MS 502. The SGSN also keeps track of individual MS's locations and security functions and access controls.

A Cell Broadcast Center (CBC) 14 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 534 provides a gateway between the GPRS network and a public packet network (PDN) or other IP networks 536. That is, the GGSN provides interworking functionality with external networks, and sets up a logical link to the MS through the SGSN. When packet-switched data leaves the GPRS network, it is transferred to an external TCP-IP network 536, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one of three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 530 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not received pages from a circuit switched domain when engaged in a data call, since the MS is receiving data and is not listening to a paging channel. In a NOM3 network, a MS can monitor pages for a circuit switched network while received data and vise versa.

The IP multimedia network 538 was introduced with 3GPP Release 5, and includes an IP multimedia subsystem (IMS) 540 to provide rich multimedia services to end users. A representative set of the network entities within the IMS 540 are a call/session control function (CSCF), a media gateway control function (MGCF) 546, a media gateway (MGW) 548, and a master subscriber database, called a home subscriber server (HSS) 550. The HSS 550 may be common to the GSM network 501, the GPRS network 530 as well as the IP multimedia network 538.

The IP multimedia system 540 is built around the call/session control function, of which there are three types: an interrogating CSCF (I-CSCF) 543, a proxy CSCF (P-CSCF) 542, and a serving CSCF (S-CSCF) 544. The P-CSCF 542 is the MS's first point of contact with the IMS 540. The P-CSCF 542 forwards session initiation protocol (SIP) messages received from the MS to an SIP server in a home network (and vice versa) of the MS. The P-CSCF 542 may also modify an outgoing request according to a set of rules defined by the network operator (for example, address analysis and potential modification).

The I-CSCF 543, forms an entrance to a home network and hides the inner topology of the home network from other networks and provides flexibility for selecting an S-CSCF. The I-CSCF 543 may contact a subscriber location function (SLF) 545 to determine which HSS 550 to use for the particular subscriber, if multiple HSS's 550 are present. The S-CSCF 544 performs the session control services for the MS 502. This includes routing originating sessions to external networks and routing terminating sessions to visited networks. The S-CSCF 544 also decides whether an application server (AS) 552 is required to receive information on an incoming SIP session request to ensure appropriate service handling. This decision is based on information received from the HSS 550 (or other sources, such as an application server 552). The AS 552 also communicates to a location server 556 (e.g., a Gateway Mobile Location Center (GMLC)) that provides a position (e.g., latitude/longitude coordinates) of the MS 502.

The HSS 550 contains a subscriber profile and keeps track of which core network node is currently handling the subscriber. It also supports subscriber authentication and authorization functions (AAA). In networks with more than one HSS 550, a subscriber location function provides information on the HSS 550 that contains the profile of a given subscriber.

The MGCF 546 provides interworking functionality between SIP session control signaling from the IMS 540 and ISUP/BICC call control signaling from the external GSTN networks (not shown). It also controls the media gateway (MGW) 548 that provides user-plane interworking functionality (e.g., converting between AMR- and PCM-coded voice). The MGW 548 also communicates with other IP multimedia networks 554.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

While example embodiments of wireless anti-theft security communications services have been described in connection with various computing devices/processors, the underlying concepts can be applied to any computing device, processor, or system capable of providing wireless anti-theft security communications services as described herein. The various techniques described herein can be implemented in connection with hardware or software or, where appropriate, with a combination of both. Thus, the methods and apparatuses for providing wireless anti-theft security communications services, or certain aspects or portions thereof, can take the form of program code (i.e., instructions) embodied in tangible storage media, such as floppy diskettes, CD-ROMs, hard drives, or any other machine-readable storage medium (computer-readable storage medium), wherein, when the program code is loaded into and executed by a machine, such as a computer, the machine becomes an apparatus for controlling a communications device in accordance with motion thereof. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for providing wireless anti-theft security communications services can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for wireless anti-theft security communications services. When implemented on a general-purpose processor, the program code combines with the processor to provide a unique apparatus that operates to invoke the functionality wireless anti-theft security communications services. Additionally, any storage techniques used in connection with wireless anti-theft security communications services can invariably be a combination of hardware and software.

While wireless anti-theft security communications services have been described in connection with the various embodiments of the various figures, it is to be understood that other similar embodiments can be used or modifications and additions can be made to the described embodiments for wireless anti-theft security communications services. For example, one skilled in the art will recognize that controlling a communications device in accordance with motion thereof as described in the present application may apply to any environment, whether wired or wireless, and may be applied to any number of such devices connected via a communications network and interacting across the network. Therefore, wireless anti-theft security communications services should not be limited to any single embodiment, but rather should be construed in breadth and scope in accordance with the appended claims.

What is claimed:

1. A wireless anti-theft security communications device comprising:
a sensor portion comprising:
a video camera configured to capture video information; and
a microphone; and at least one of:
a pressure sensor configured to detect pressure against the wireless anti-theft security communications device; or
an accelerometer configured to detect motion of the wireless anti-theft security communications device;
a processing portion configured to, upon an indication from the sensor portion of a security breach;
initiate capture of video information via the video camera;
initiate capture of acoustic information via the microphone; and
initiate a wireless communications session; and
an input/output portion configured to;
provide, to a designated destination via the wireless communications session, the video information; and
provide, to a designated destination via the wireless communications session, the acoustic information.

2. The wireless anti-theft security communications device in accordance with claim 1, wherein the designated destination is a wireless communications device.

3. The wireless anti-theft security communications device in accordance with claim 2, wherein the wireless anti-theft security communications device is remotely programmable via the wireless communications device.

4. The wireless anti-theft security communications device in accordance with claim 2, wherein a predefined ringtone on the wireless communications device indicates that the wireless anti-theft security communications device is providing information to the wireless communications device.

5. The wireless anti-theft security communications device in accordance with claim 2, wherein the video camera is remotely controllable via the wireless communications device.

6. The wireless anti-theft security communications device in accordance with claim 5, wherein controlling the video camera comprising controlling at least one of:
an angle of the video camera;
a focus of the video camera;
a light sensitivity of the video camera; or
a zoom factor of the video camera.

7. The wireless anti-theft security communications device in accordance with claim 1, wherein the designated destination is a database.

8. The wireless anti-theft security communications device in accordance with claim 1, wherein the designated destination is a security entity.

9. The wireless anti-theft security communications device in accordance with claim 1, the procession portion further configured to distinguish between a security breach and an event known not to be a security breach.

10. The wireless anti-theft security communications device in accordance with claim 1, further configured to provide an indication of a location of the wireless anti-theft security communications device.

11. A wireless anti-theft security communications service comprising:
a wireless anti-theft security communications device made available to a subscriber, the wireless anti-theft security communications device comprising:
a sensor portion comprising:
a video camera configured to capture video information; and
a microphone; and at least one of:
a pressure sensor configured to detect pressure against the wireless anti-theft security communications device; or
an accelerometer configured to detect motion of the wireless anti-theft security communications device;
a processing portion configured to, upon an indication from the sensor portion of a security breach;
initiate capture of video information via the video camera;
initiate capture of acoustic information via the microphone; and
initiate a wireless communications session; and
an input/output portion configured to;
provide, to a designated destination via the wireless communications session, the video information; and
provide, to a designated destination via the wireless communications session, the acoustic information;
wherein, upon detection of a security breach, at least one of the video information or the audio information is automatically provided to the designated destination.

12. The wireless anti-theft security communications service in accordance claim 11, wherein, upon detection of a security breach, at least one of the video information or the audio information is automatically provided to a plurality of designated destinations.

13. The wireless anti-theft security communications service in accordance claim 11, further comprising:
a user interface portion configured to allow entry of an indication of the designated destination, wherein, upon detection of a security breach, at least one of the video information or the audio information is automatically provided to the designated destination via the user interface portion.

14. The wireless anti-theft security communications service in accordance claim 11, the wireless anti-theft security communications device further configured to provide an indication of a location of the wireless anti-theft security communications device.

15. The wireless anti-theft security communications service in accordance claim 11, wherein, upon detection of a security breach, at least one of the video information or the audio information is automatically provided to the designated destination comprising a secure storage device.

16. The wireless anti-theft security communications service in accordance claim 11, wherein, upon detection of a security breach, at least one of the video information or the audio information is automatically provided to the designated destination comprising a security entity.

17. The wireless anti-theft security communications service in accordance claim 11, wherein the wireless anti-theft security communications device is one of remotely activateable, remotely deactivateable, or remotely controllable via an authorized party other than the subscriber of the wireless anti-theft security communications service.

18. The wireless anti-theft security communications service in accordance claim 17, wherein the subscriber is provided an incentive to allow the authorized party the ability to one of remotely activate, remotely deactivate, or remotely control the wireless anti-theft security communications device.
